(19) United States
(12) Patent Application Publication
(10) Pub. No.: US 2003/0062410 A1
(43) Pub. Date: Apr. 3, 2003

(54) Providing incentives for the purchase of efficient vehicles

(75) Inventors: Michael Wayne Brown, Georgetown, TX (US); Rabindranath Dutta, Austin, TX (US); Michael A. Paolini, Austin, TX (US); Newton James Smith JR., Austin, TX (US)

Correspondence Address: Marilyn Smith Dawkins, International Business Machines Corporation, Intl Prop Law Dept., Internal Zip 4054, 11400 Burnet Road, Austin, TX, 78758, US

(73) Assignee: International Business Machines Corporation, Armonk, NY

(21) Appl. No.: 09/968,779

(22) Filed: Oct. 2, 2001

(51) Int. Cl. G07B 15/02

(52) U.S. Cl. 235/384

(57) ABSTRACT

A method, system, and program for providing incentives for the purchase of efficient vehicles are provided. A vehicle purchase record is received, wherein the vehicle purchase record identifies a type of vehicle and a buyer. A particular incentive is automatically selected according to an efficiency of the type of vehicle. The incentive is transferred as an electronic payment for the buyer, such that the buyer is provided with the incentive for a purchase of an efficient vehicle.

### BACKGROUND OF THE INVENTION

1. Technical Field

The present invention relates in general to computer systems and, in particular, to conservation of energy facilitated by computer systems. Still more particularly, the present invention relates to providing incentives for the purchase of efficient vehicles.

2. Description of the Related Art

Conservation of energy, water, and other resources is of interest globally as resources become more scarce and expensive. Government policy continues to be revised in an attempt to influence citizens' actions with regard to energy consumption. However, many of these policies involve savings that occur after a long period of time with an initial investment by the consumer, and thus are not well taken advantage of. Also, many policies do not provide a large enough incentive for most people to change conservation habits.

In particular, vehicle manufacturers continue to improve automotive technology to improve vehicle efficiency. However, consumers still continue to purchase less efficient, larger vehicles, and not utilize the vehicle capacity. By purchasing less efficient vehicles and not utilizing the capacity of those vehicles, consumers utilize more fuel, oil, and other resources than is necessary for transportation.

Governments may place requirements on auto manufacturers to produce vehicles with a particular standard of efficiency to adjust the types of products that are available to consumers. However, even with such requirements, the consumer often pays the extra cost for the increased efficiency.

Therefore, in view of the foregoing, it would be advantageous to provide a method, system, and program for providing incentives to consumers to purchase energy efficient vehicles to increase the demand for such types of vehicles.

### SUMMARY OF THE INVENTION

In view of the foregoing, it is therefore an object of the present invention to provide an improved computer system.

It is another object of the present invention to provide a method, system and program for conservation of energy, facilitated by computer systems.

It is yet another object of the present invention to provide a method, system and program for providing incentives for the purchase of efficient vehicles.

According to one aspect of the present invention, a vehicle purchase record is received, wherein the vehicle purchase record identifies a type of vehicle and a buyer. A particular incentive is automatically selected according to an efficiency of the type of vehicle. The incentive is transferred as an electronic payment for the buyer, such that the buyer is automatically provided with the incentive for a purchase of an efficient vehicle.

All objects, features, and advantages of the present invention will become apparent in the following detailed written description.

### DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which promoting and controlling energy conservation may be performed in accordance with the method, system and program of the present invention;

FIG. 3 depicts a block diagram of multiple types of servers and clients that may be utilized to promote and control energy conservative purchases in accordance with the method, system, and program of the present invention;

FIG. 4 illustrates a block diagram of a system for the purchase of efficient vehicles in accordance with the method, system, and program of the present invention;

FIG. 5 depicts a vehicle purchase record with incentive provided in accordance with the method, system, and program of the present invention;

FIG. 6 illustrates a high level logic flowchart of a process and program for determining incentives for efficient vehicle purchases in accordance with the method, system, and program of the present invention; and

FIG. 7 depicts a high level logic flowchart of a process and program for providing vehicle purchase records to obtain incentives for buyers in accordance with the method, system, and program of the present invention.

### DESCRIPTION OF THE PREFERRED EMBODIMENT

A method, system, and program for providing incentives for the purchase of efficient vehicles are provided. In the present embodiment, incentives are advantageously redeemable electronic payments that may be applied toward vehicle related costs. For example, incentives may be applied towards sales tax and vehicle registration in the form of a credit, a rebate, or a tax rebate. In particular, for purposes of the present invention, incentives for the purchase of efficient vehicles are preferably those provided by an authority, such as the government, and therefore distinguishable from incentives provided by automakers.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### HARDWARE OVERVIEW

The present invention may be executed in a variety of systems, including a variety of computing systems and electronic devices under a number of different operating systems. In one embodiment of the present invention, the systems may include a portable computing system such as a notebook computer, a palmtop computer, a personal digital assistant, a telephone or other electronic computing system that may also incorporate communications features that provide for telephony, enhanced telephony, messaging and information services. However, the systems may also include, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

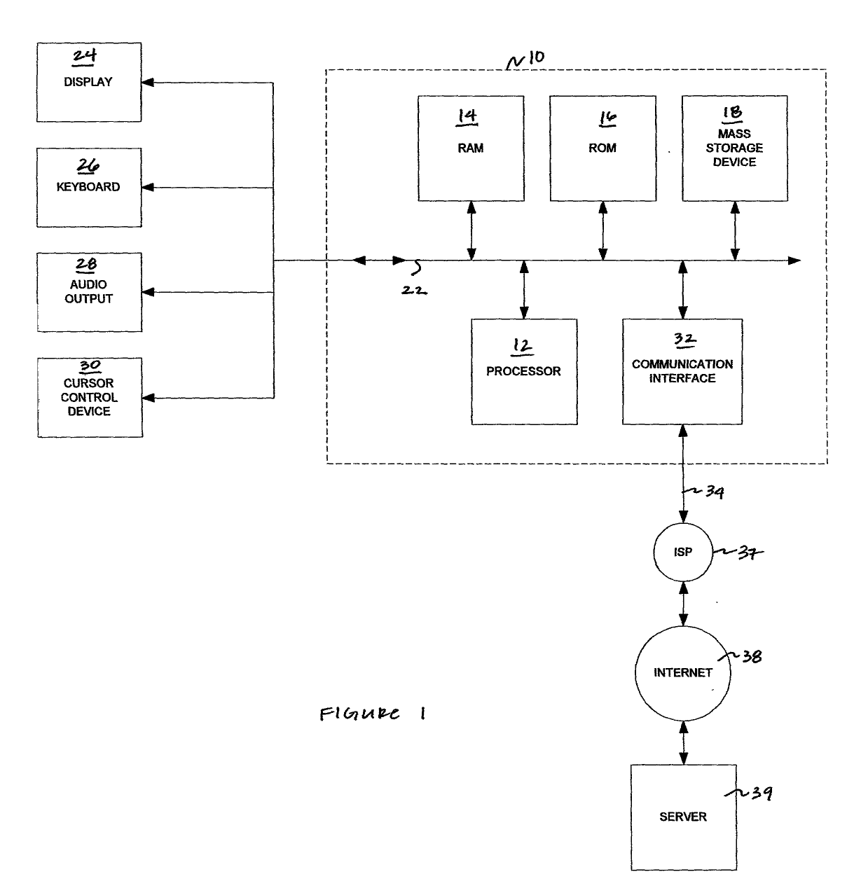

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

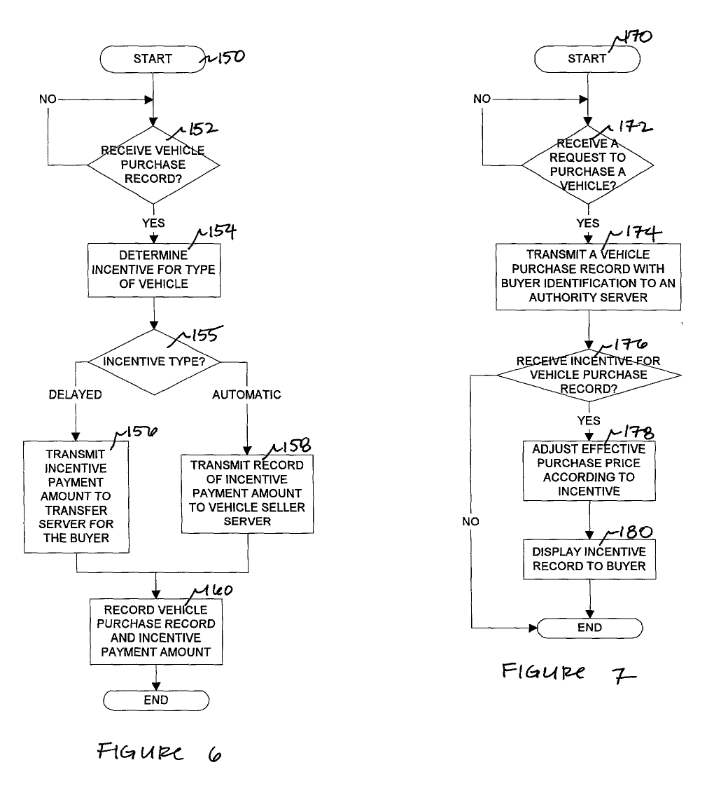

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 6, 7, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### NETWORKING OVERVIEW

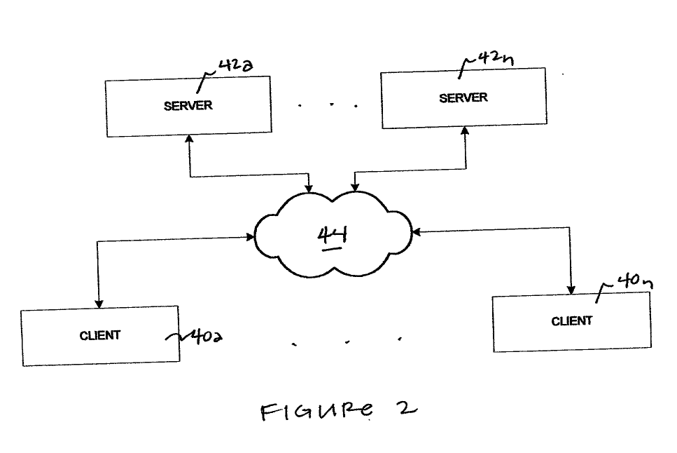

With reference now to FIG. 2, there is depicted a simplified block diagram of a client/server environment in which promoting and controlling energy conservation may be performed in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client system 40a-40n and render Web documents (pages) served by server systems 42a-42n. Additionally, each of client systems 40a-40n and server systems 42a-42n may function as both a “client” and a “server” and may be implemented utilizing a computer system such as computer system 10 of FIG. 1.

The Web may refer to the total set of interlinked hypertext documents residing on servers all around the world. Network 44, such as the Internet, provides an infrastructure for transmitting these hypertext documents between server systems 42a-42n and client systems 40a-40n. Documents (pages) on the Web may be written in multiple languages, such as Hypertext Markup Language (HTML) or Extensible Markup Language (XML), and identified by Uniform Resource Indicators (URIs) that specify the particular server and pathname by which a file can be accessed, and then transmitted from that server to an end user utilizing a protocol such as Hypertext Transfer Protocol (HTTP). Web pages may further include text, graphic images, movie files, and sounds as well as Java applets and other small embedded software programs that execute when the user activates them by clicking on a link.

It is advantageous in the present invention to utilize both wireless and wired network connections to network 44. Wireless network connections may be implemented utilizing Bluetooth™ or other long and short distance radio frequency broadcasting or infrared transmissions. Advantageously, whether wireless or wired network connections are utilized, multiple types of encryption security features may be utilized to protect transmission of vehicle and driver identity information, as will be understood by one skilled in the art.

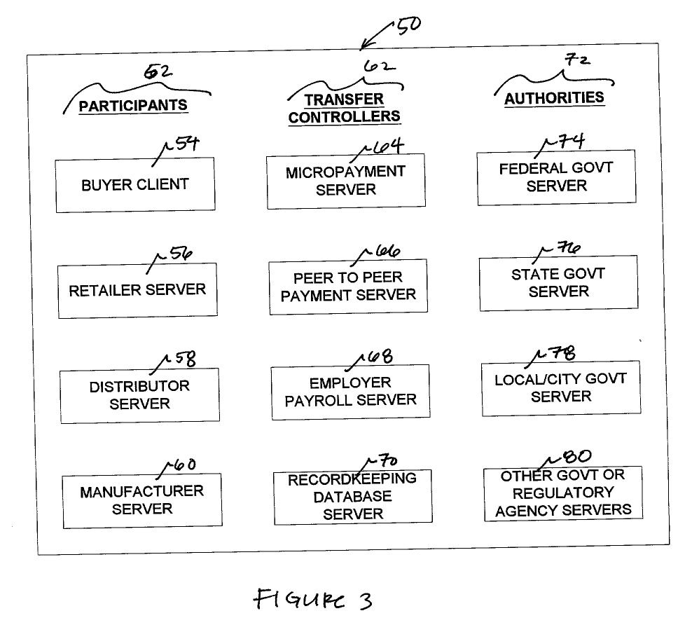

Referring now to FIG. 3, there is depicted a block diagram of multiple types of servers and clients that may be utilized to promote and control energy conservative purchases in accordance with the method, system, and program of the present invention. As illustrated, multiple client and server elements 50 are divided according to category. In the present embodiment categories include, but are not limited to, participants 52, transfer controllers 62, and authorities 72.

Participants 52 advantageously include all levels of people, businesses, and corporations involved in energy conservation. In the present embodiment, participants 52 include, but are not limited to, a buyer client 54, a retailer server 56, a distributor server 58, and a manufacturer server 60. Buyer client 54 may represent a system utilized by a buyer to purchase a vehicle. For example, where a buyer purchases a vehicle online, the personal computer system utilized by the buyer is represented by buyer client 54. However, buyer client 54 is not limited to a personal computer system and may also include, for example, a system into which buyer information is input at the retailer. Retailer server 56, distributor server 58 and manufacturer server 60 are preferably vehicle distribution servers that maintain an inventory of purchases from base retailer to manufacturer.

Transfer controllers 62 advantageously include all levels of controllers that may be provided for adjusting monetary amounts in response to conservation or lack of conservation by at least one of participants 52. In the present embodiment, transfer controllers 62 include, but are not limited to, a micropayment server 64, a peer-to-peer payment server 66, an employer payroll server 68, and a recordkeeping database server 70. Micropayment server 64 may be an internal account system into which incentives for purchasing efficient vehicles are transmitted and from which the electronic payments may be utilized for vehicle related costs by the entity providing the incentive. Alternatively, peer-to-peer payment server 66 is an external account system into which incentives for purchasing efficient vehicles are transmitted, but from which the electronic payments may be utilized by a consumer for payments external to the entity providing the incentive. Employer payroll server 68 is a system that records employee pay and adjusts employee pay according to pre-tax adjustments, such as incentives. Recordkeeping database server 70 maintains a recording of all incentives given and includes a recording of tax rebates and other incentives that are to be applied after a point of purchase.

Authorities 72 advantageously include all levels of government and policy setting groups that may be responsible for setting policy and standards for calculating and providing monetary incentives to conservation or lack of conservation by at least one of participants 52. In the present example, authorities 72 specifically includes federal government (govt) server 74, state government server 76, local/city government server 78, and other government or regulatory agency servers 80. In particular, in the present invention, consumers may receive incentives from authorities 72 for purchasing energy efficient vehicles. However, retailers, distributors and manufacturers may also receive monetary incentives for selling, distributing and producing energy efficient vehicles, such that those savings may be passed on to the consumer or utilized to supplement costs for developing more energy efficient technology.

### PURCHASE OF EFFICIENT VEHICLES CONTEXT

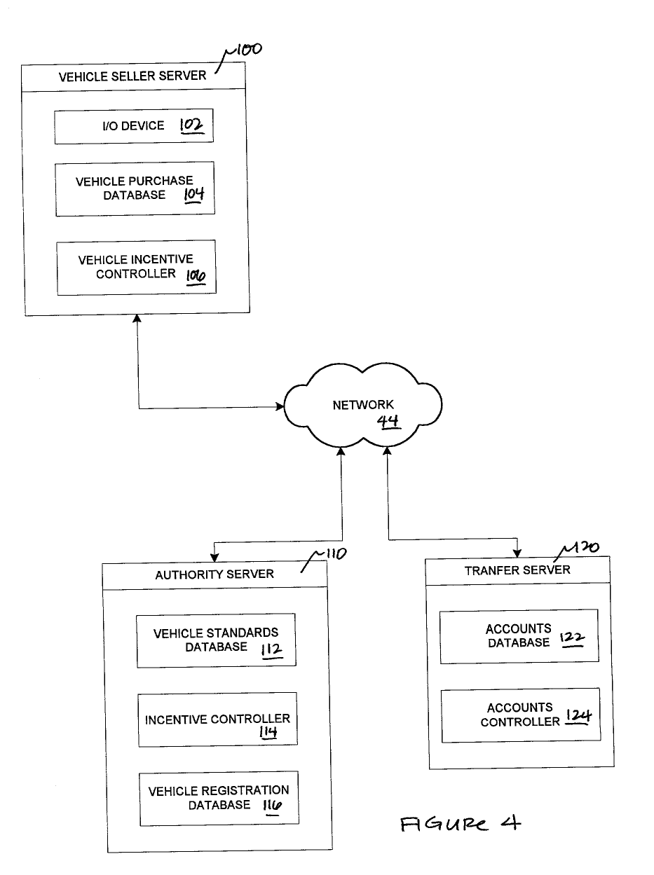

With reference now to FIG. 4, there is depicted a block diagram of an incentive system for the purchase of efficient vehicles in accordance with the method, system, and program of the present invention. As illustrated, multiple server systems are communicatively connected via network 44.

According to one advantage of the present invention, each vehicle seller (retailer, distributor, manufacturers) is enabled to provide records of vehicle purchases to an authority and is also enabled to receive records of incentives given to buyers according to the vehicle purchased. In the present example, vehicle seller server 100 preferably includes a input/output (I/O) device 102, a vehicle purchase database 104, and a vehicle incentive controller 106. Vehicle purchase database 104 records purchases of vehicles according to buyer. Vehicle incentive controller 106 transmits the record of purchase to an authority server 110, such that any incentives provided to the buyer may be determined by authority server 110.

In alternate embodiments, other systems may be utilized to provide records of vehicle purchases in order for buyers to receive incentives. For example, a vehicle registration system may provide records of vehicle purchases such that incentives may be provided to a buyer. In particular, where a buyer is purchasing a used vehicle, it is advantageous to utilize a vehicle registration system, provided by an authority for registering vehicles.

Authority server 110 may represent at least one of multiple authorities depicted in FIG. 3. In the present example, authority server includes a vehicle standards database 112, an incentive controller 114, and a vehicle registration database 116. Advantageously, when vehicle purchase records are received, incentive controller 114 compares the type of vehicle purchased with incentive standards in vehicle standards database 112. An incentive may then be determined depending on whether the vehicle purchased is one for which incentives are being provided. The vehicle purchase record and record of any incentive payment are stored in vehicle registration database 116. In alternate embodiments, vehicle registration database 116 may be stored at an alternate record keeping server.

Incentives determined by incentive controller 114 may be in multiple forms including, but not limited to, a credit, a rebate, or a tax reduction. In particular, according to one advantage of the present invention, incentives are applied towards other vehicle related costs, such as vehicle sales tax and vehicle registration costs.

Further, the incentive payment amount may be transmitted from authority server 110 to either vehicle seller server 100 or transfer server 120. If transmitted to vehicle seller server 100, then the incentive is automatically applied to the purchase price of the vehicle. For example, where a sales tax reduction is provided as an incentive for purchase of an efficient vehicle, then that sales tax reduction is transmitted to vehicle seller server 100 to be reduced from the cost of the vehicle. Or, for example, where a vehicle registration reduction is provided as an incentive for purchase of an efficient vehicle, then the vehicle registration credit is transmitted to transfer server 120. Further, incentives payment amounts may be stored in vehicle registration database 116, such that a vehicle owner receives a yearly registration bill at a rate reduced by the incentive payment amount.

Transfer server 120 may represent at least one of multiple transfer controllers depicted in FIG. 3. In the present example, transfer server 120 includes an accounts database 122 for storing electronic accounts for multiple users. In addition, an accounts controller 124 controls reductions and additions to accounts database 122. Where incentive payments are received at transfer server 120, those payments are preferably stored in accounts database 122 according to user. Advantageously, by receiving electronic incentive payments in a user account, the user may automatically receive a financial incentive to purchase an efficient vehicle.

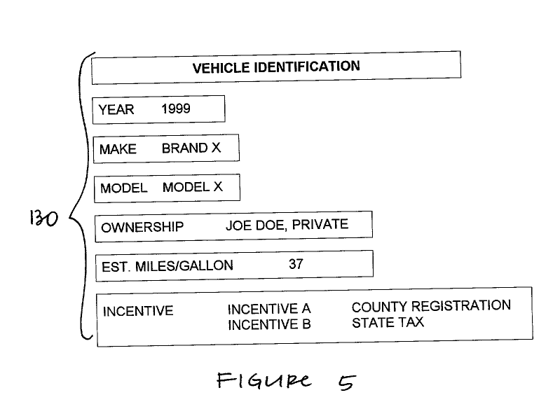

Referring now to FIG. 5, there is illustrated a vehicle purchase record with incentive provided in accordance with the method, system, and program of the present invention. As depicted, a record 130 includes a year, make, and model of a vehicle. Advantageously, incentive standards are determined by an authority system according to the year, make, and model of a vehicle.

Further, record 130 includes the ownership, estimated efficiency and incentives provided. In the present example, efficiency is provided by estimated miles per gallon. In alternate embodiments, alternate types of efficiency estimates may be included. Efficiency estimates may also be utilized in incentive standards for authority systems.

Advantageously, each successive owner of a vehicle may be traced where there are multiple owners. In addition, advantageously each owner of a vehicle may receive an incentive for vehicles that maintain efficiency. For example, each owner of a vehicle may receive a yearly incentive as a reduction to a vehicle registration cost.

In the example, incentives are provided by both county and state entities to alleviate costs associated with vehicle purchases. In particular, in the example, the county assesses a vehicle registration fee and therefore may provide an incentive of a reduction in the vehicle registration fee. In addition, the state assesses a tax on the purchase of a vehicle and therefore may provide an incentive of a reduction in the vehicle registration fee.

With reference now to FIG. 6, there is depicted a high level logic flowchart of a process and program for determining incentives for purchases of efficient vehicles in accordance with the method, system, and program of the present invention. As illustrated, the process starts at block 150 and thereafter proceeds to block 152.

Block 152 depicts a determination as to whether a vehicle purchase record is received at an authority server. If a vehicle purchase record is not received, then the process iterates at block 152. If a vehicle purchase record is received, then the process passes to block 154.

Block 154 illustrates determining an incentive for the type of vehicle included in the purchase record; and the process passes to block 155. The incentive is determined by comparing the vehicle type with vehicle incentive standards designated by an authority providing the incentive.

Block 155 depicts a determination as to what type of incentive is determined. If an automatic incentive is determined, then the process passes to block 158. If a delayed incentive is determined, then the process passes to block 156.

Block 156 depicts transmitting the incentive payment amount to a transfer server for the buyer; and the process passes to block 158. Preferably, where a vehicle registration fee reduction is provided as an incentive, the application of the incentive may be delayed over multiple years, and thus stored in the transfer server for the buyer.

Block 158 illustrates transmitting the record of the incentive payment amount to the vehicle seller server; and the process passes to block 160. Preferably, where a tax incentive is provided, the incentive is automatically applied to the purchase price of the vehicle, and therefore the tax incentive is transmitted to the vehicle seller server for application to the purchase price.

Block 160 depicts recording the vehicle purchase record and incentive amount at the authority server system; and the process ends.

Referring now to FIG. 7, there is illustrated a high level logic flowchart of a process and program for providing vehicle purchase records to obtain incentives for buyers in accordance with the method, system, and program of the present invention. As depicted, the process starts at block 170 and thereafter proceeds to block 172.

Block 172 depicts a determination as to whether or not a request to purchase a vehicle is received. If a request to purchase a vehicle is not received, then the process iterates at block 172. If a request to purchase a vehicle is received, then the process passes to block 174.

Block 174 illustrates transmitting a vehicle purchase record with buyer identification to an authority server to request incentives. Next, block 176 depicts a determination as to whether an incentive is returned for the vehicle. If an incentive is not received, then the process ends. If an incentive is received, then the process passes to block 178.

Block 178 depicts adjusting the effective purchase price of the vehicle according to the incentive. Next, block 180 illustrates displaying the incentive to the buyer; and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for providing incentives for purchase of efficient vehicles, said method comprising the steps of:
receiving a vehicle purchase record, wherein said vehicle purchase record identifies a type of vehicle and a buyer;
automatically selecting a particular incentive according to an efficiency of said type of vehicle; and
transferring said incentive as an electronic payment for said buyer, such that said buyer is automatically provided with said incentive for a purchase of an efficient vehicle.

2. The method for providing incentives according to claim 1, said step of receiving a vehicle purchase record, further comprising the step of:
receiving said vehicle purchase record from a vehicle seller server communicatively connected to a network.

3. The method for providing incentives according to claim 1, said step of receiving a vehicle purchase record, further comprising the step of:
receiving said vehicle purchase record from a vehicle registration database communicatively connected to a network via an authority server.

4. The method for providing incentives according to claim 1, said step of selecting a particular incentive according an efficiency of said type of vehicle, further comprising the step of:
selecting said particular incentive from a plurality of incentives offered by at least one government entity for said efficiency of said type of vehicle.

5. The method for providing incentives according to claim 1, said step of transferring said incentive as an electronic payment for said buyer further comprising the step of:
transferring said incentive as said electronic payment to at least one from among a transfer server, a vehicle seller server, and an authority server.

6. The method for providing incentives according to claim 1, said step of transferring said incentive as an electronic payment for said buyer further comprising the step of:
transferring said incentive as a sales tax credit.

7. The method for providing incentives according to claim 1, said step of transferring said incentive as an electronic payment for said buyer further comprising the step of:
transferring said incentive as a vehicle registration credit.

8. A system for providing incentives for purchase of efficient vehicles, said system comprising:
a server system communicatively connected to a network;
said server system further comprising:
means for receiving a vehicle purchase record via said network, wherein said vehicle purchase record identifies a type of vehicle and a buyer;
means for automatically selecting a particular incentive according to an efficiency of said type of vehicle; and
means for transferring said incentive as an electronic payment for said buyer via said network.

9. The system for providing incentives according to claim 8, said means for receiving a vehicle purchase record, further comprising:
means for receiving said vehicle purchase record from a vehicle seller server communicatively connected to said network.

10. The system for providing incentives according to claim 8, said means for receiving a vehicle purchase record, further comprising:
means for receiving said vehicle purchase record from a vehicle registration database communicatively connected to said network.

11. The system for providing incentives according to claim 8, said means for selecting a particular incentive according an efficiency of said type of vehicle, further comprising:
means for selecting said particular incentive from a plurality of incentives offered by at least one government entity for said efficiency of said type of vehicle.

12. The system for providing incentives according to claim 8, said means for transferring said incentive as an electronic payment for said buyer further comprising:
means for transferring said incentive as said electronic payment to at least one from among a transfer server, a vehicle seller server, and an authority server.

13. The system for providing incentives according to claim 8, said means for transferring said incentive as an electronic payment for said buyer further comprising:
means for transferring said incentive as a sales tax credit.

14. The system for providing incentives according to claim 8, said means for transferring said incentive as an electronic payment for said buyer further comprising:
means for transferring said incentive as a vehicle registration credit.

15. A program for providing incentives for purchase of efficient vehicles, residing on a computer usable medium having computer readable program code means, said program comprising:
means for enabling receipt of a vehicle purchase record, wherein said vehicle purchase record identifies a type of vehicle and a buyer;
means for automatically selecting a particular incentive according to an efficiency of said type of vehicle; and
means for controlling a transfer of said incentive as an electronic payment for said buyer.

16. The program for providing incentives according to claim 15, said program further comprising:
means for selecting said particular incentive from a plurality of incentives offered by at least one government entity for said efficiency of said type of vehicle.

17. The program for providing incentives according to claim 15, said program further comprising:
means for controlling said transfer of said incentive as said electronic payment to at least one from among a transfer server, a vehicle seller server, and an authority server.

18. The program for providing incentives according to claim 15, said program further comprising:
means for controlling said transfer of said incentive as a sales tax credit.

19. The program for providing incentives according to claim 15, said program further comprising:
means for controlling said transfer of said incentive as a vehicle registration credit.

20. A method for applying an incentive for a purchase of an efficient vehicle, said method comprising the steps of:
transferring to an authority server an indicator of a purchaser of a vehicle; and
in response to receiving an efficient vehicle incentive from said authority server for said purchaser of said vehicle, applying said incentive to a cost associated with purchase of said vehicle, such that purchase of said efficient vehicle is promoted.

21. The method for applying an incentive for a purchase of an efficient vehicle according to claim 20, said method further comprising the step of:
receiving said efficient vehicle incentive for said purchaser of said vehicle only where said vehicle meets an efficient vehicle standard.

22. The method for applying an incentive for a purchase of an efficient vehicle according to claim 20, said step of applying said incentive to a cost associated with purchase of said vehicle, further comprising the step of:
applying said incentive to a purchase price of said vehicle.

23. The method for applying an incentive for a purchase of an efficient vehicle according to claim 20, said step of applying said incentive to a cost associated with purchase of said vehicle, further comprising the step of:
applying said incentive to a tax included in a purchase price of said vehicle.

24. The method for applying an incentive for a purchase of an efficient vehicle according to claim 20, said step of applying said incentive to a cost associated with purchase of said vehicle, further comprising the step of:
applying said incentive to a vehicle registration cost for said vehicle.

25. A system for applying an incentive for a purchase of an efficient vehicle, said system comprising:
a server system communicatively connected to a network;
said server system further comprising:
means for transferring to an authority server an indicator of a purchaser of a vehicle; and
means for applying said incentive to a cost associated with purchase of said vehicle, in response to receiving an efficient vehicle incentive for said purchaser of said vehicle.

26. The system for applying an incentive for a purchase of an efficient vehicle according to claim 25, said system further comprising:
means for receiving said efficient vehicle incentive for said purchaser of said vehicle only where said vehicle meets an efficient vehicle standard.

27. The system for applying an incentive for a purchase of an efficient vehicle according to claim 25, said means for applying said incentive to a cost associated with purchase of said vehicle, further comprising:
means for applying said incentive to a purchase price of said vehicle.

28. The system for applying an incentive for a purchase of an efficient vehicle according to claim 25, said means for applying said incentive to a cost associated with purchase of said vehicle, further comprising:
means for applying said incentive to a tax included in a purchase price of said vehicle.

29. The system for applying an incentive for a purchase of an efficient vehicle according to claim 25, said means for applying said incentive to a cost associated with purchase of said vehicle, further comprising:
means for applying said incentive to a vehicle registration cost for said vehicle.

30. A program for applying an incentive for a purchase of an efficient vehicle, residing on a computer usable medium having computer readable program code means, said program comprising:
means for controlling a transfer of an indicator of a purchaser of a vehicle; and
means for applying said incentive to a cost associated with purchase of said vehicle, in response to detecting receipt of an efficient vehicle incentive for said purchaser of said vehicle.

31. The program for applying an incentive for a purchase of an efficient vehicle according to claim 30, said program further comprising:
means for detecting receipt of said efficient vehicle incentive for said purchaser of said vehicle only where said vehicle meets an efficient vehicle standard.

32. The program for applying an incentive for a purchase of an efficient vehicle according to claim 30, said program further comprising:
means for applying said incentive to a purchase price of said vehicle.

33. The program for applying an incentive for a purchase of an efficient vehicle according to claim 30, said program further comprising:
means for applying said incentive to a tax included in a purchase price of said vehicle.

34. The program for applying an incentive for a purchase of an efficient vehicle according to claim 30, said program further comprising:
means for applying said incentive to a vehicle registration cost for said vehicle.
